(19) United States
(12) Patent Application Publication
(10) Pub. No.: US 2026/0099721 A1
(43) Pub. Date: Apr. 9, 2026

(54) SYNTHETIC CORRUPTION OF MACHINE LEARNING OUTPUT

(71) Applicant: Microsoft Technology Licensing, LLC, Redmond, WA (US)

(72) Inventors: Rachel WITIES, Givat Shmuel (IL); Aaron BORNSTEIN, ZICHRON YA’AKOV (IL); Hadas BITRAN, Ramat Hasharon (IL); Ran EFRATI, Tel-Aviv (IL)

(21) Appl. No.: 18/933,073

(22) Filed: Oct. 31, 2024

Related U.S. Application Data
(60) Provisional application No. 63/704,303, filed on Oct. 7, 2024.

(51) Int. Cl. G06N 3/094; G06N 3/0475

(52) U.S. Cl. CPC G06N 3/094; G06N 3/0475

(57) ABSTRACT

A corrupter may receive first output data of a designated domain from the large language model. The corrupter may synthesize qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

### CROSS-REFERENCE TO RELATED APPLICATIONS

The present application claims benefit for priority to U.S. Provisional Patent Application No. 63/704,303, entitled "SYNTHETIC CORRUPTION OF MACHINE LEARNING OUTPUT" and filed on Oct. 07, 2024, which is specifically incorporated by reference herein for all that it discloses and teaches.

### BACKGROUND

As generative artificial intelligence (AI) technologies continue to improve and gain popularity, AI models are increasingly relied upon for text generation tasks, such as question answering, text simplification, text summarization, etc. A significant unresolved issue in these tasks is the difficulty of evaluating the quality of generated output. Even when references are available, comparing the output of AI models to these references and assessing the quality of the AI models (e.g., detecting hallucinations and omissions) remains a complex task.

### SUMMARY

In some aspects, the techniques described herein relate to a method of corrupting output data generated by a large language model for training a safeguard model, the method including: receiving first output data of a designated domain from the large language model; and synthesizing qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

In some aspects, the techniques described herein relate to a system for corrupting output data generated by a large language model for training a safeguard model, including: one or more hardware processors; a communication interface executable by the one or more hardware processors and configured to perform operations including receiving first output data of a designated domain from the large language model; and a synthesizer executable by the one or more hardware processors and configured to perform operations including synthesizing qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

In some aspects, the techniques described herein relate to one or more tangible processor-readable storage media embodied with instructions for executing on one or more processors and circuits of a computing device a process for corrupting output data generated by a large language model for training a safeguard model, the process including: receiving first output data of a designated domain from the large language model; and synthesizing qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment for evaluating, b a safeguard model, output data of a large language model (LLM).

FIG. 2 illustrates an example computing environment for generating, using a corrupter from output data of a large language model (LLM), corrupted output data for training a safeguard model.

FIG. 3 illustrates an example computing environment for generating, using a corrupter from output data of an LLM, corrupted output data.

FIG. 4 illustrates an example computing environment for generating, using a corrupter from output data of an LLM, corrupted output data.

FIG. 5 illustrates a portion of an ontology.

FIG. 6 illustrates the application of a corruption rule instructing to replace an entity detected in output data that corresponds to a first concept of an ontology with a second concept in the ontology associated with the same category as the first concept.

FIG. 7 illustrates the application of a corruption rule instructing to replace a concept detected in the output data with another concept in an ontology that is within a range of edges away from the concept in the ontology.

FIG. 8 illustrates the application of a corruption rule instructing to replace an entity detected in output data that corresponds to a first concept in an ontology with a second concept in the ontology that co-occurs with the concept.

FIG. 9 illustrates the application of a corruption rule instructing to replace a value associated with an entity detected in the output data corresponding to a concept of an ontology with another value.

FIG. 10 depicts an example operations for corrupting output data generated by a large language model for training an error detection model.

FIG. 11 illustrates an example computing device for use in implementing the described technology.

### DETAILED DESCRIPTIONS

Even when references (e.g., ground truth values) are available, comparing the output of AI models to these references and assessing the quality of the AI models (e.g., detecting hallucinations and omissions) remains a complex task. This issue is even more pronounced in fields (e.g., the medical field, journalism, etc.) where generative tasks involve complex content that is highly sensitive to nuances in semantics and lexicon and where the outputs of AI models are of vital importance. For example, expert language often uses a broad array of terms to describe the same observation, and conversely, a minor change in phrasing can result in a significant distinction in meaning. Furthermore, many generative applications involve layperson non-expert lexicon (question answering, clinical text simplification, search in an online forum etc.) which creates yet another variety of ways to refer to the same issue.

Some methodologies for evaluating the output of AI models (e.g., large language models (LLMs)) include using machine learning (ML) safeguard models to identify errors in AI model outputs. For example, safeguard models can flag potential errors and/or hallucinations in AI model outputs. Training safeguard models involves corrupting output data of AI models and then using the corrupted output data to train the ML safeguard models. However, a scarcity of negative examples of LLM-produced errors exists for use as training data. Approaches to generating corrupted output data include corruption using ML models and manual corruption by human experts. ML model approaches to generating training data for safeguard models are not trained to corrupt AI output data in ways that are domain-specific. For example, in the medical field, safeguard models need to be trained to recognize clinical errors, which may require more sophisticated or nuanced corruptions of AI output data than ML model approaches may provide. Further, manual corruption of data introduces bias as human generators may have a particular level of knowledge of the domain and may not anticipate or contemplate the types of errors that could potentially be made by those who are more or less knowledgeable than the human generators.

The technology disclosed herein addresses these inadequacies of training safeguard models by providing improved methods for generating synthetic corrupted AI model output data for training safeguard models to recognize errors and omissions. The disclosed technology provides a corrupter model that uses a domain-specific ontology (e.g., a medical ontology or other domain-specific ontology) to guide the corruption of AI model output data for the generation of safeguard model training data.

An ontology is a formal data structure that represents knowledge about a specific domain (e.g., medical diseases). It organizes concepts properties of the concepts (e.g., attributes, hierarchical relationships) in a structured way. For example, the ontology may use a graph structure where nodes represent concepts and edges represent properties. Properties can include hierarchical relationships. For example, classes represent categories or types of objects in the domain and define a set of concepts with common characteristics. An individual, also known as an instance, represents a single, concrete object that belongs to a class. For example, a class (e.g., category) node may include one or multiple individual (e.g., instance) nodes within the class. In this example, the class may itself be an instance node of a higher class and one or more of the instance nodes may also be a class node with further instance nodes within the class. Properties describe attributes of classes or individuals (e.g., data properties) and define relationships between them (e.g., object properties). For example, data properties specify characteristics or attributes of a class or individual and are associated with specific data values (e.g., numerical, textual, etc.). Object properties define relationships between individuals. Ontologies may be structured hierarchically, where classes are organized into a superclass-subclass (e.g., parent-child) relationship. The ontology may include logical statements or rules (e.g., axioms) that define how classes, individuals, and properties interact. For example, the ontology may require that every instance of the disease class have a relationship to at least one instance of the symptoms class.

Certain implementations of the disclosed technology use specific corruption rules in combination with ontologies to control the extent of corruption of AI model output data for generating training data for training safeguard models. The corruption rules ensure that the types of corruption used to generate the training data are relevant to the domain (e.g., medicine, products, law, etc.) in which the safeguard model will be employed. A user may configure the corruption rules to generate safeguard model training data with desired types of corruption that are applicable to specific domains of knowledge represented by an ontology. The customizable corruption rules control how the corrupter uses the ontology to corrupt the AI model output data. Using ontologies and customizable corruption rules, the technology disclosed herein improves the quality of corrupted AI model output data used as training data for training safeguard models. Consequently, safeguard models trained using training data generated using the disclosed technology have a significantly improved performance over safeguard models trained using training data generated using alternative methods (e.g., manual human generation using human judgment or non-domain-specific models that do not utilize ontologies).

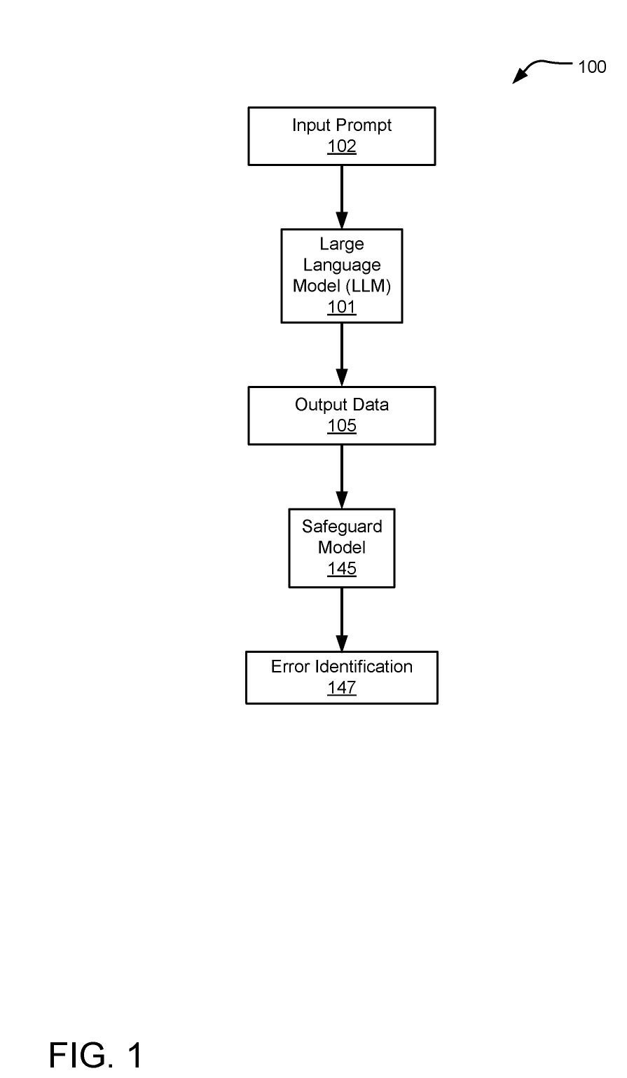

FIG. 1 illustrates an example computing environment 100 for evaluating, by a safeguard model 145, output data 105 of a large language model (LLM) 101. The example computing environment 100 includes an LLM 101 and a safeguard model.

The LLM 101, in some implementations, is trained to process and respond to LLM prompts (e.g., input prompt 102, for example, a natural language query) and to provide output data 105 that is specific to a knowledge domain and that is responsive to the LLM prompts. For example, the knowledge domain is medical diagnoses. In other examples, the knowledge domain is insurance law, ethics in journalism, or other knowledge domain and the output data 105 is responsive to an LLM prompt and is relevant to the knowledge domain. Examples of LLMs include transformer-based models (e.g., a generative pre-trained transformer (GPT) model, an Open Pretrained Transformer (OPT) model, or Bioscience Large Open-science Open-access Multilingual (BLOOM) model), as well as seq2seq models, long short-term memory networks (LSTM), and recurrent neural networks (RNNs).

As depicted in FIG. 1, responsive to an input prompt, the LLM 101 generates output data 105. For example, the input prompt 102 may be a natural language query requesting a medical diagnosis for a list of symptoms. An example of an input prompt 102 is “I have a fever greater than 101 degrees Fahrenheit, chills, and muscle aches. Do I have a virus?” and example output data 105 responsive to this input prompt 102 is a medical diagnosis and other explanatory data (e.g., a treatment recommendation).

The safeguard model 145 generates, for the output data 105, an error identification 147. For example, the safeguard model 145 may recognize errors (e.g., omissions, substitutions of related concepts/concepts, etc.) that are present in the output data 105. In some implementations, the error identification 147 includes one or more words, symbols, phrases, or other portions of the output data 105 that include error(s). In some implementations, the error identification 147 identifies potential errors in the output data 105 for user review. In some implementations, the error identification 147 includes, for each of one or more portions of the output data 105, a probability that the portion of the output data 105 includes an error.

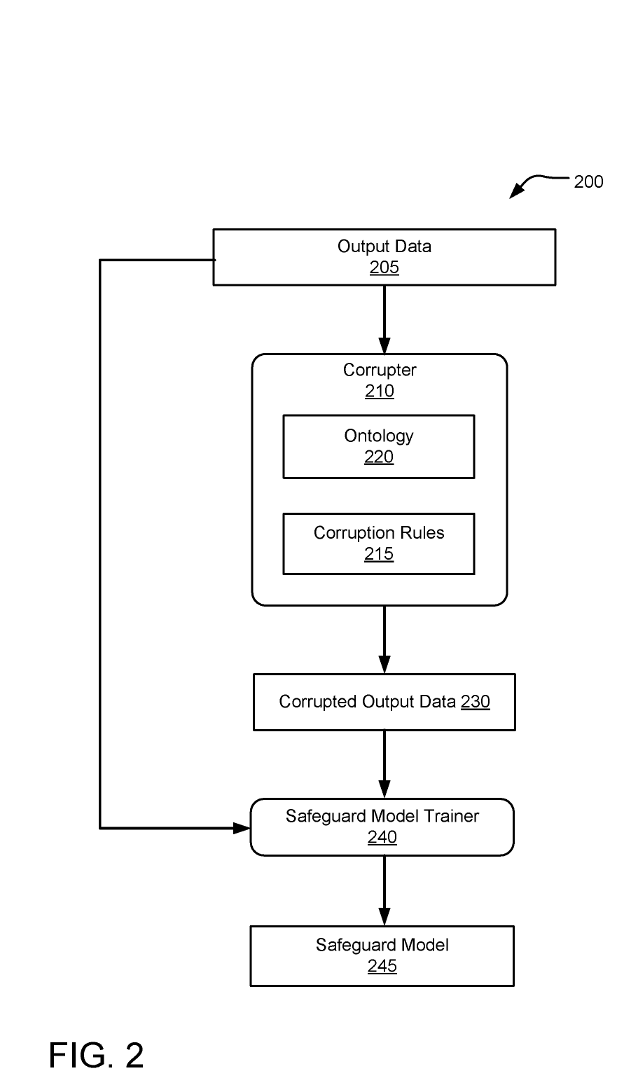

FIG. 2 illustrates an example computing environment 200 for generating, using a corrupter 210 from output data 205 of a large language model (LLM) 201, corrupted output data 230 for training a safeguard model. The example computing environment 200 includes a corrupter 210 and a safeguard model 245.

The LLM in some implementations, is trained to process and respond to LLM prompts (e.g., natural language queries) and to provide output data 205 that is specific to a knowledge domain and that is responsive to the LLM prompts.

The corrupter 210 generates corrupted output data 230 from the output data 205 of the LLM. In some implementations, the output data 205 that is input to the corrupter 210 is selected based on its accuracy. For example, output data 205 that is accurate to the knowledge domain is selected for input to the corrupter 210 so that it can be used as ground truth against corrupted output data 230 generated by the corrupter 210.

The corrupter 210 generates the corrupted output data 230 using corruption rules 215 and an ontology 220 that is specific to the knowledge domain of the safeguard model and of the LLM. The corrupter 210 generates the corrupted output data 230 for training a safeguard model to recognize the types of errors that the corrupter 210 introduced into the output data 205 when it generated the corrupted output data 230.

The corruption rules 215 specify how the corrupter 210 uses the ontology 220 to corrupt the output data 205. For example, corruption rules 215 may instruct the corrupter 210 to replace an entity detected in the output data 205 with a concept in the ontology 220 associated with the same category as another concept in the ontology 220 that corresponds to the entity. For example, corruption rules 215 may instruct the corrupter 210 to replace an entity detected in the output data 205 with a concept in the ontology 220 that is within a range of edges away from another concept in the ontology 220 corresponding to the detected entity. For example, corruption rules 215 may instruct the corrupter 210 to replace an entity with a concept of the ontology 220 that co-occurs with another concept in the ontology that corresponds to the entity. In some implementations, the corruption rules 215 instruct the corrupter 210 to replace a value (e.g., a number, a dosage number, etc.) of the entity with a value associated with a value of a second concept of the ontology 220 that is related to a first concept of the ontology 220 that corresponds to the entity. For example, a value of the entity is “rosuvastatin 20 mg,” which corresponds to concept “rosuvastatin 20 mg” of the ontology. In this example, concept “rosuvastatin 20 mg” is related (e.g., is an instance of a same category, “rosuvastatin”) to the concept “rosuvastatin 40 mg” and has the value of 40 instead of 20. In this example, value “rosuvastatin 20 mg” may be replaced with “rosuvastatin 40 mg” in accordance with corruption rules. In another implementation, corruption rules 215 may instruct the corrupter 210 to replace a value (e.g., a number) of the entity with a value associated with an alternative value of a concept of the ontology 220 that corresponds to the entity.

The corruption rules 215 described herein are examples, and other corruption rules 215 may be used to define how the corrupter 210 corrupts the output data 205 using or based on the ontology 220 to generate the corrupted output data 230. In some instances, the corruption rules 215 define multiple corruption rules 215 and a percentage of detected concepts within the output data 205 to which to apply each of the corruption rules 215. For example, the corruption rules 215 specify to apply a first rule to 2% of detected entities and/or values within the output data 205 and to apply a second rule to 1% of detected entities and/or values within the output data 205. In this example, the corrupter 210 detects a set of concepts and/or values of the ontology 220 that are present in the output data 205 and, using a selection algorithm (e.g., random selection), selects a number of entities to which to apply each corruption rule in accordance with the corresponding percentages specified in the corruption rules 215.

In some implementations, one or more users (e.g., experts, laypeople, or users having ordinary skill in the knowledge domain) select, define, and/or configure the corruption rules 215 and generate the ontology 220. For example, users may generate an ontology 220 for the corrupter or select an existing ontology that is stored in a memory and is accessible to the corrupter 210.

In some implementations, the corrupted output data 230 generated by the corrupter 210 is used by a safeguard model trainer 240 to train a safeguard model 245 (e.g., an error detection model) to recognize, in output data of LLMs, the types of errors (e.g., omissions, substitutions of related concepts/concepts using the ontology 220, etc.) that are present in the corrupted output data 230. For example, the safeguard model 245 is trained to recognize the types of errors that the corruption rules 215 instructed the corrupter 210 to introduce into the output data 205 when generating the corrupted output data 230.

In some implementations, the safeguard model 245 is trained by determining a loss between errors identified by the safeguard model 245 in the corrupted output data 230 to labeled errors in the corrupted output data 230 (e.g., the labeled errors determined from a delta between the corrupted output data 230 and the output data 205) and then modifying one or more parameters of the safeguard model to minimize the loss. For example, the errors in the corrupted output data 230 can be labeled by determining a delta between the corrupted output data 230 and the output data 205 to determine specific words in the corrupted output data 230 that comprise the errors.

In certain implementations, the safeguard model 245 is trained using a supervised learning approach. The training process involves calculating a loss function based on the difference between the predicted errors identified by the safeguard model 245 in the corrupted output data 230 and the actual labeled errors in in the corrupted output data 230. These labeled errors are determined by computing the delta (or difference) between the corrupted output data 230 and the original output data 205. The model parameters (weights and biases) are then adjusted iteratively using backpropagation to minimize the loss function, thereby improving the model’s ability to detect specific erroneous words or tokens in the corrupted output data 230.

In some implementations, corrupted output data is generated from output data of other types of models other than LLMs, for example, output data of voice-to-text models and/or image-to-text models. In these implementations, the text output of such models is corrupted by the corrupter 210 using an ontology specific to the knowledge domain of the other type(s) of models. For example, a diagnostic model uses an image input (e.g., a scan of a patient’s lungs) and generates a text output (e.g., text labels for features of the image) and the corrupter uses an ontology to guide the corruption of the text output.

In some implementations, data structures other than an ontology may be used by the corrupter 210 to guide the corruption of the output data 205. For example, knowledge graphs, relational databases, or other data structures that include domain-related concepts (e.g., categories, instances) with properties and connected to each other by relations may be used instead of or in addition to ontologies.

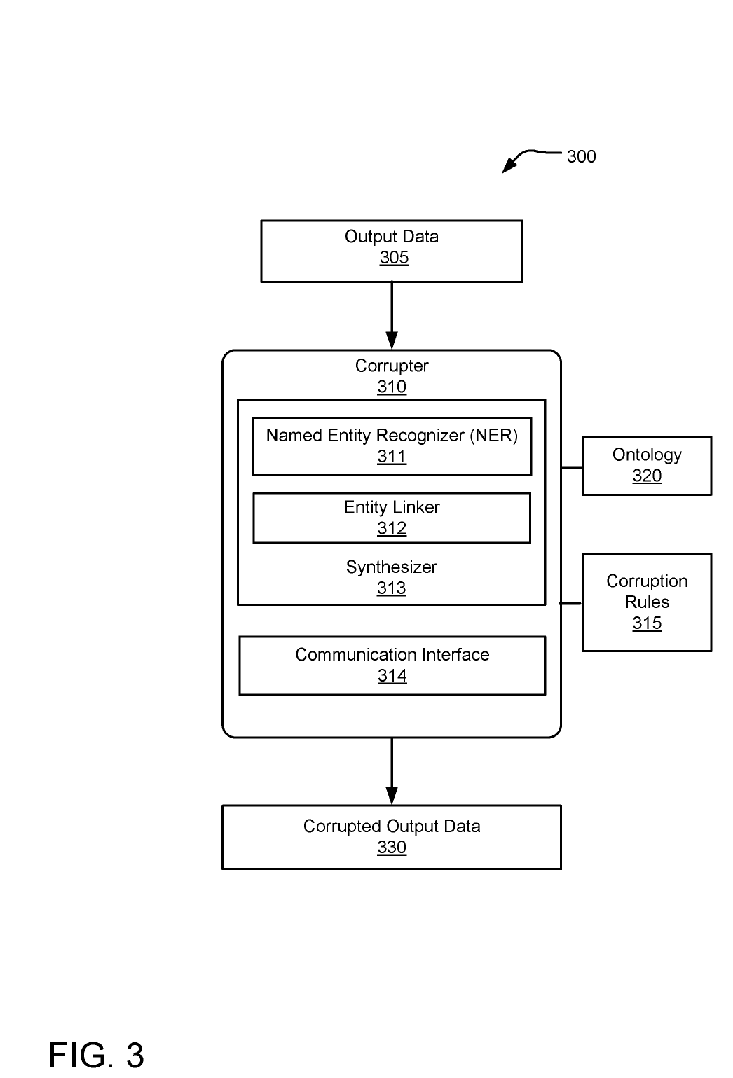

FIG. 3 illustrates an example computing environment 300 for generating, using a corrupter 310 from output data 305 of an LLM, corrupted output data 330. The example computing environment 300 includes a corrupter 310.

The corrupter 310 generates corrupted output data 330 from the output data 305 of an LLM, for example, an LLM that generates output data 305 that is pertinent to a specific knowledge domain. The corrupter 310 generates the corrupted output data 330 using corruption rules 315 and an ontology 320 that is specific to the knowledge domain. For example, corrupter 310 generates the corrupted output data 230 for training a safeguard model to recognize the types of errors that the corrupter 310 introduced into the output data 305 when it generated the corrupted output data 330. The corruption rules 315 specify how the corrupter 310 uses the ontology 320 to corrupt the output data 305.

In some implementations, the corrupter 310 includes a communication interface 314 and a synthesizer 313. The communication interface 314 receives output data 305 generated by an LLM. The communication interface 314 can access the ontology 320, and the corruption rules 315, which, in some implementations, are stored in a memory accessible to the communication interface 314. In some implementations, the communication interface 314 outputs the corrupted output data 330. For example, the communication interface 314 may transmit the corrupted output data 330 to a safeguard model trainer for training a safeguard model.

The synthesizer 313 generates the corrupted output data 330 by replacing, in the output data 305, entities detected by the NER 311 with one or more replacement concepts and/or replacement values identified in the ontology 320 by the concept linker 312. The synthesizer 313 replaces the detected entities with the replacement concepts/values in accordance with the corruption rules 315 to generate the corrupted output data 330.

The synthesizer 313, in some implementations, includes a named concept recognizer (NER) 311. The NER 311 detects, in the output data 305, entities that correspond with concepts of the ontology 320. In some implementations, the NER 311 detects entities in the output data 305 that are relevant to one or more corruption rules 315. For example, the corruption rules 315 instruct the corrupter 310 to replace the entity, which is associated with a concept (e.g., a first diagnosis) in the ontology 320, with another concept (e.g., a second diagnosis) from the ontology 320 in a same class as the concept. In this example, the NER 311 detects an entity associated with a concept of the ontology 320 within the output data 305 so that the corrupter 310 can replace the one or more detected entities in accordance with the corruption rules 315. In some implementations, the NER 311 identifies a value of an entity in accordance with the corruption rules 315. In some implementations, the NER 311 applies a parsing algorithm to parse the output data 305 of the LLM model into tokens (e.g., phrases, words, sentences, etc.) and then identifies which tokens correspond to concepts or values within the ontology 320. In some implementations, the parsing algorithm also determines synonyms of one or more parsed tokens, and the NER 311 finds a correspondence between one or more of the synonyms and concepts or values within the ontology 320.

In some implementations, the synthesizer 313 includes a concept linker 312. The concept linker 312 can traverse (e.g., navigate, scan, etc.) the ontology 320 in accordance with the corruption rules 315 to determine one or more replacement concepts within the ontology 320 to replace an entity detected by the NER 311 within the output data 305. For example, the corruption rules 315 instruct the corrupter 310 to replace an entity detected by the NER 311 in the output data 305 with another concept associated with a same category as a concept associated with the entity in the ontology 320. In this example, the concept linker 312 identifies, in the ontology 320, the concept associated with the detected entity of the output data 305, finds the category (e.g., class node) of which the detected concept is an instance node, and then finds another instance node of the category node. In this example, the concept of the other instance node that is found by the concept linker 312 may replace the detected entity in accordance with the corruption rules 315. The concept linker 312, in some implementations, identifies a candidate concept (e.g., class or instance) with which to replace an entity in the output data 305 detected by the NER 311. In some implementations, the concept linker 312 identifies a candidate value of a concept in the ontology 320 with which to replace a value of an entity detected in the output data 305 by the NER 311.

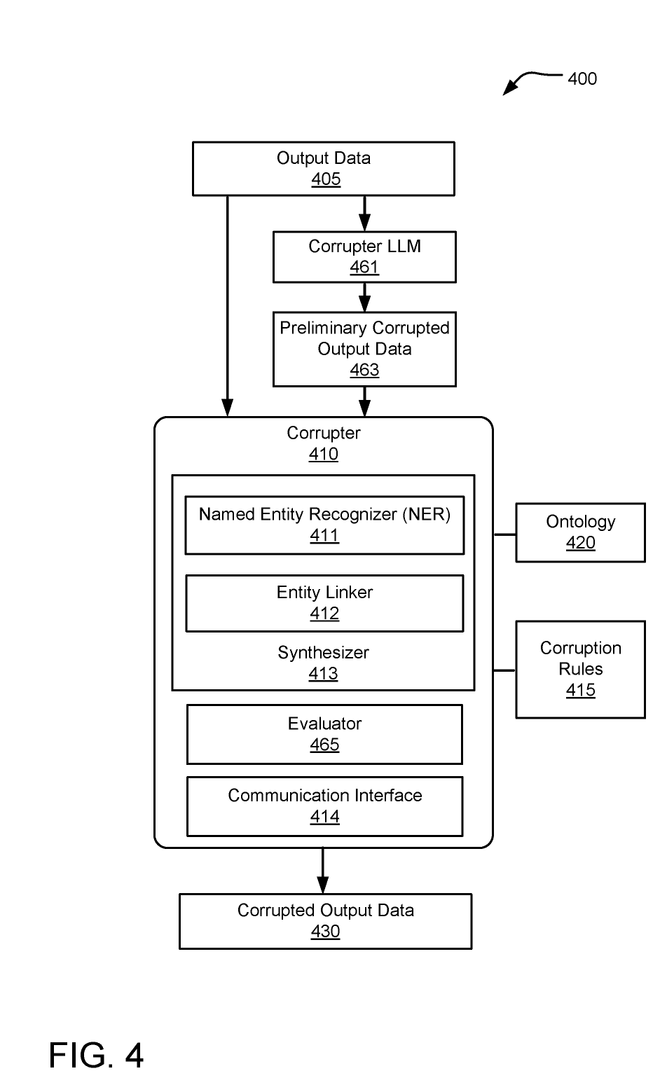

FIG. 4 illustrates an example computing environment 400 for generating, using a corrupter 410 from output data 405 of an LLM, corrupted output data 430. The example computing environment 400 includes a corrupter 410.

In some implementations, a corrupter LLM 461 is used to generate preliminary corrupted output data 463 from the output data 405, and the corrupter 410 evaluates (e.g., using the evaluator 465) whether the preliminary corrupted output data 463 was generated in accordance with corruption rules 415. For example, the corrupter LLM 461 receives the output data 405 as an input, along with a prompt asking to corrupt the output data 405. In these implementations, the corrupter 410 determines the suitability of the preliminary corrupted output data 463. For example, instead of applying corruption rules 415 using the ontology 420 to generate corrupted output data 430, the corrupter 410 determines whether or not the preliminary corrupted output data 463 satisfies the corruption rules 415.

For example, the corrupter 410 compares the output data 405 to the preliminary corrupted output data 463 to determine how the output data 405 was corrupted by the corrupter LLM 461 and determines, using the ontology 420, whether the corruption in the preliminary corrupted output data 463 satisfies the corruption rules 415. The corrupter 410 includes a synthesizer 313, a communication interface 314, and an evaluator 465.

For example, the synthesizer 413 of the corrupter 410 may include an NER 411 and an entity linker 312. The NER 411 can identify entities referenced in one or more of the output data 405 or the preliminary corrupted output data 463. The concept linker 412 can determine concepts of the ontology 420 associated with the detected entities and relationships within the ontology 420 of concepts and/or values in the output data 405 that replaced the detected entities in the preliminary corrupted output data 463. For example, the concept linker 412 may determine that an entity in the output data 405 that is associated with a first concept in the ontology 420 was changed to a second concept of another instance in the same category as the first concept, was changed to a second concept that is a particular number of edges away from the first concept, was changed to a second concept that has a cooccurrence relationship with the first concept, was changed to a second concept by traversing the ontology 420 in a particular manner (e.g., one node up then one node down), and so forth.

The evaluator 465 evaluates the determined relationships (e.g., between a concept associated with the original entity in the output data 405 and a concept associated with a replacement entity that replaced the entity in the preliminary corrupted output data 463) to determine whether they comply with the corruption rules 415. In some scenarios, the determined relationships between entities and the replacement concepts comply with the corruption rules 415, and the corrupter 410 outputs the preliminary corrupted output data 463 as the corrupted output data 430. In some implementations, the determined relationships between entities and the replacement concepts do not comply with the corruption rules 415, and the corrupter 410 requests the corrupter LLM 461 to re-generate the preliminary corrupted output data 463. The request may include a message that the preliminary corrupted output data 463 is not satisfactory in view of the corruption rules 415. For example the corrupter LLM 461, responsive to receiving the request, generates subsequent preliminary corrupted output data 463. In some implementations, the determined relationships between entities and the replacement concepts do not comply with the corruption rules 415, and the corrupter 410 modifies one or more replacement concepts of the preliminary corrupted output data 463 to comply with the corruption rules 415 and outputs the modified preliminary corrupted output data as the corrupted output data 430.

The corrupter 410 (e.g., the communication interface 414) outputs the corrupted output data 430, in some implementations, for training a safeguard model to recognize the types of errors present in the corrupted output data 430 compared to the output data 405. The corruption rules 415 specify how the corrupter 410 uses the ontology 420 to verify the adequacy of the preliminary corrupted output data 463 or otherwise correct the preliminary corrupted output data 463 so that it complies with the corruption rules 415.

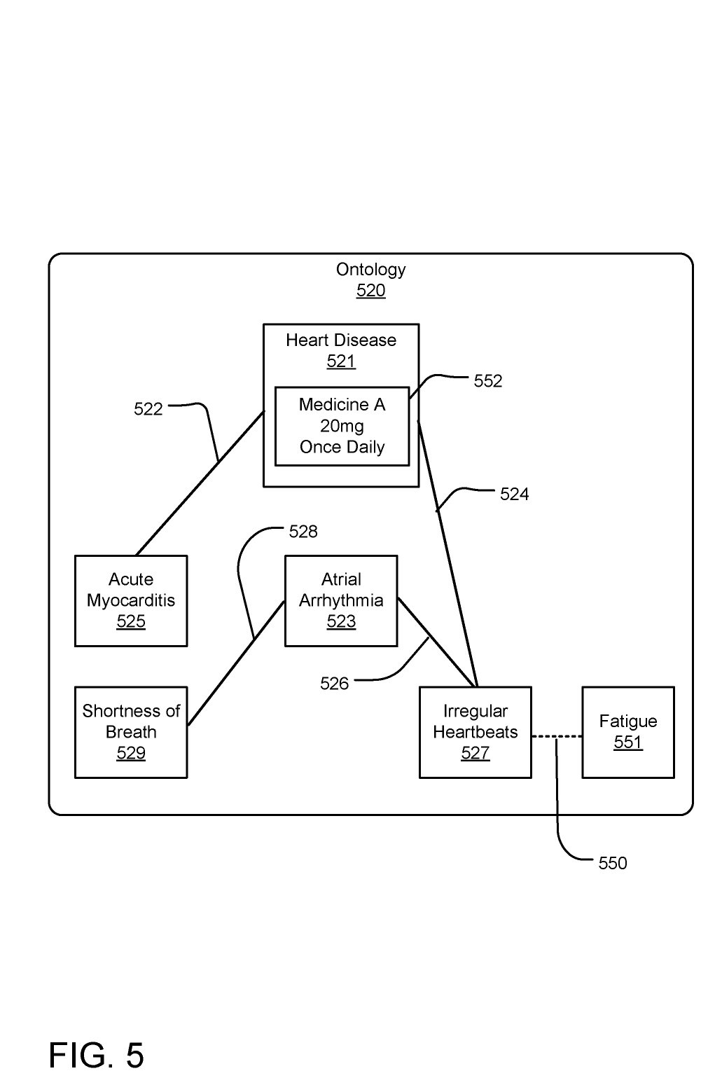

FIG. 5 illustrates a portion of an ontology 520. The ontology 520 is represented using a graph structure. The nodes in the depicted portion of the ontology 520 represent concepts including heart disease 521, atrial arrhythmia 523, acute myocarditis 525, irregular heartbeats 527, shortness of breath 529, and fatigue 551. The nodes are connected via edges (e.g., edge 522, edge 524, edge 526, edge 528, edge 550). Each of the concepts of the ontology 520 may include object properties that define relationships of the concept with other concepts. In the portion of the ontology 520 depicted in FIG. 5, the object properties of the concepts include a class (e.g., a category such as “disease”) to instance (e.g., a symptom of the disease) relationship, which is depicted in FIG. 5 using a top-down relationship. For example, the heart disease 521 node is connected via edge 524 to the irregular heartbeats 527 node below, indicating that irregular heartbeats 527 is an instance of the class of heart disease 521. For example, irregular heartbeats 527 and shortness of breath 529 are both instances (e.g., symptoms of) the class (e.g., diagnosis) of atrial arrhythmia 523. The dashed line of the edge 550 represents a relationship of co-occurrence. For example, co-occurrence indicates that fatigue 551 symptoms are likely to occur at the same time (or in the same patient) as a symptom of irregular heartbeats 527. In some implementations, the co-occurrence relationship is not represented in the ontology itself. Instead, a co-occurrence database is accessed, and a set of concepts of the ontology co-occurring with the concept corresponding to the entity is extracted. Although not illustrated in FIG. 5, the fatigue 551 concept node may be connected to one or more additional nodes that are not depicted in FIG. 5 via one or more single arrow edges (e.g., that depict a relationship of class to instance) that are not depicted in FIG. 5.

Each of the concepts of the ontology 520 (e.g., heart disease 521, atrial arrhythmia 523, acute myocarditis 525, irregular heartbeats 527, shortness of breath 529, and fatigue 551) may include data properties (e.g., data property 552), for example, a Unified Medical Language System (UMLS) code representing the concept, a text description describing the concept, a treatment regimen, or other data properties. For example, data properties of certain concepts (e.g., acute myocarditis 525, atrial arrhythmia 523, heart disease 521) may include suggested medications and dosage guidelines for treatment or management of the disease indicated by the concept. For example, data property 552 associated with the heart disease 521 concept node represents a treatment regimen of “Medicine A, 20 mg once daily.” The ontology 520 is one example of an ontology and the concepts and their relationships may be mapped differently than the mapping provided in the example ontology 520. For example, a medication (with a dosage) may be represented by an instance node, connected to a category node by the edge “X cures Y”. For example, a Heart Disease concept may be connected to a “Medicine A 20 milligram” concept by “X cures Y” connection and, therefore, the “Medicine A 20 milligram” concept will be a concept hierarchically under the “medicine A” concept. Further, the example ontology 520 is in a medical knowledge domain, but ontologies in other knowledge domains (e.g., criminal law, civil law, journalism, chemistry, etc.) may be used to corrupt output data of LLMs (or other models) that are associated with the other knowledge domains, as appropriate.

The graph structure depicted in FIG. 5 is one example of a data structure that can be used to represent ontology. However, an ontology may also be represented using a hierarchical tree structure, a table, a taxonomy, or other data structures. The example portion of the ontology 520 illustrated in FIG. 5 is referenced herein in subsequent examples of applications of corruption rules that the corrupter may use to generate corrupted output data.

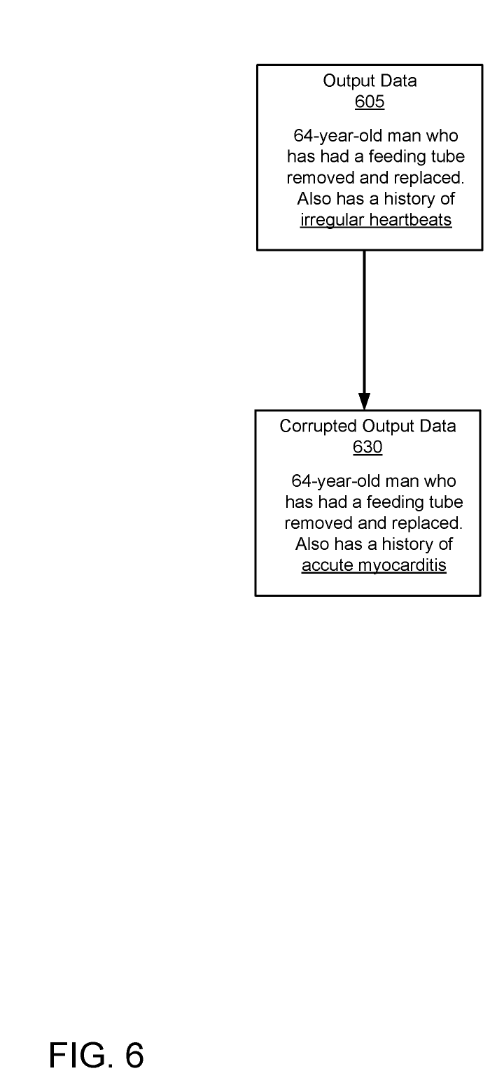

FIG. 6 illustrates the application of a corruption rule instructing to replace an entity detected in output data that corresponds to a first concept of an ontology with a second concept in the ontology associated with the same category as the first concept. In the example illustrated in FIG. 6, the corrupter accesses output data 605 of an LLM that reads “64-year-old man who has had a feeding tube removed and replaced. Also has a history of irregular heartbeats.” The corrupter detects the phrase “irregular heartbeats” as an entity in the output data and determines that the detected entity corresponds to the concept of “irregular heartbeats” in an ontology, for example, the ontology 520 illustrated in FIG. 5. In some implementations, the corrupter can detect a correspondence between the entity in the output data and the concept in the ontology even when the terms are not identical. For example, if the output data 605 used the term “cardiac arrhythmia” instead of “irregular heartbeats,” the corrupter would still detect a correspondence between “cardiac arrhythmia” in the output data 605 and “irregular heartbeats” in the ontology 520. For example, the irregular heartbeats 527 node may include a list of synonyms (e.g., “irregular heartbeat,” “nonregular heartbeat,” “cardiac arrhythmia,” etc.). In another example, the corrupter accesses a dictionary or other database to determine synonymous terms to entities detected in the output data 605.

In the example of FIG. 6, the corruption rule instructs the corrupter to replace an entity detected in output data that corresponds with a first concept in the ontology with a second concept in the ontology that is associated with the same class (e.g., category) as the concept. For example, from the ontology 520 of FIG. 5, the corrupter determines that irregular heartbeats 527 is an instance node of the class node, heart disease 521, and identifies acute myocarditis 525 as another instance node of heart disease 521. Accordingly, the corrupter replaces “irregular heartbeats” in the output data 605 with “acute myocarditis” in the corrupted output data 630. Accordingly, the corrupted output data 630 reads, “64-year-old man who has had a feeding tube removed and replaced. Also has a history of acute myocarditis.”

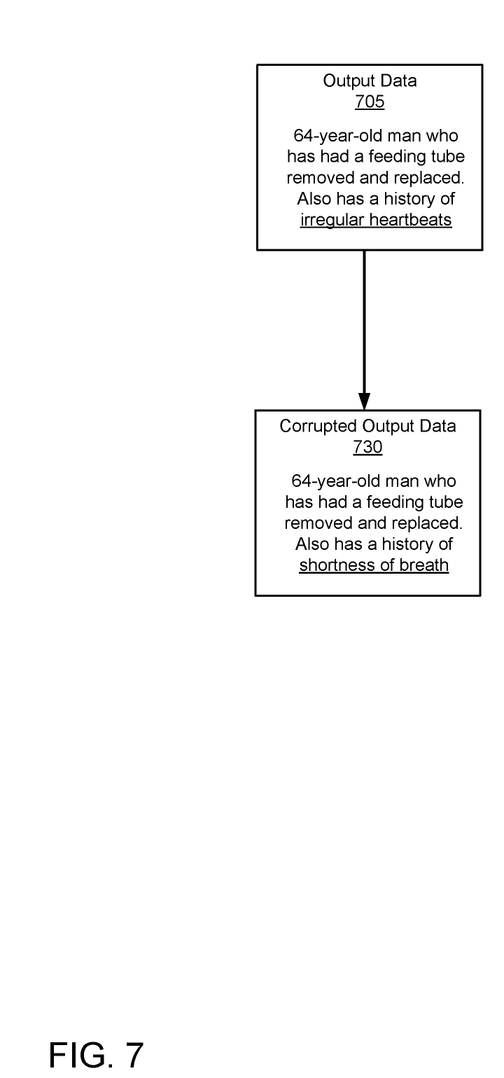

FIG. 7 illustrates the application of a corruption rule instructing to replace a concept detected in the output data with another concept in an ontology that is within a range of edges away from the concept in the ontology. In the example illustrated in FIG. 7, the corrupter accesses output data 705 of an LLM that reads “64-year-old man who has had a feeding tube removed and replaced. Also has a history of irregular heartbeats.” The corrupter detects that the phrase “irregular heartbeats” in the output data corresponds to the concept of “irregular heartbeats” in an ontology, for example, the ontology 320 illustrated in FIG. 3.

In the example of FIG. 7, the corruption rule instructs the corrupter to replace an entity detected in the output data that is associated with a first concept in an ontology with a second concept in that ontology that is within a range of edges away from the first concept in the ontology. For example, the range of edges is between 2 and 5, meaning that the second concept must not be less than two edges away and not more than five edges away from the first concept in the ontology. In certain implementations, users may configure the range of edges. For example, a lower range of edges (for example minimum 2 and maximum 3) would create corruptions that are more similar to each other than a wider range of edges (for example minimum 1 and maximum 5). In an example, the corrupter determines, from the ontology 520 of FIG. 5, that the shortness of breath 529 node is two edges away from the irregular heartbeats 527 node (e.g., the corrupter must traverse edge 526 and edge 528 to reach the shortness of breath 529 node). The distance of 2 edges is within the range of edges. Accordingly, the corrupter replaces the “irregular heartbeats” entity in the output data 705 with “shortness of breath” in the corrupted output data 730. Accordingly, the corrupted output data 730 reads, “64-year-old man who has had a feeding tube removed and replaced. Also has a history of shortness of breath.”

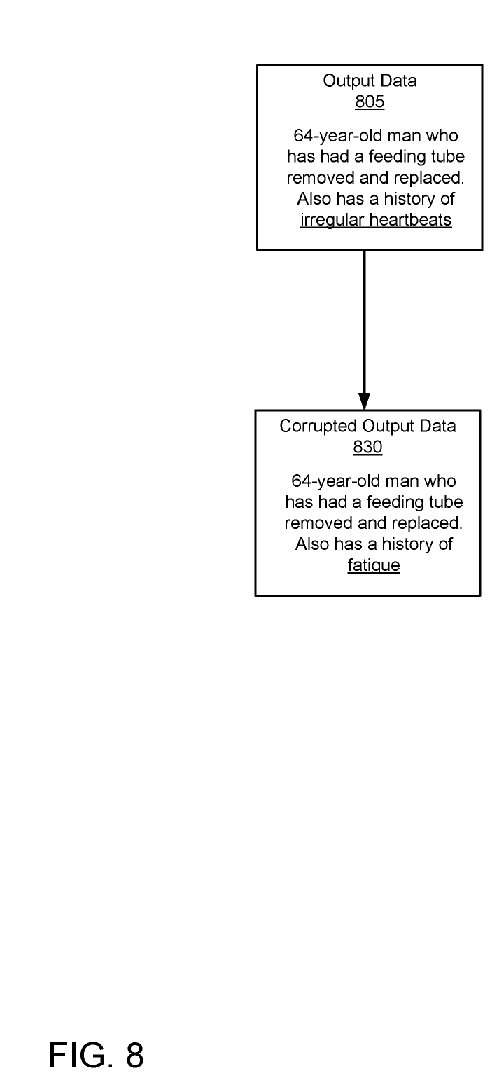

FIG. 8 illustrates the application of a corruption rule instructing to replace an entity detected in output data that corresponds to a first concept in an ontology with a second concept in the ontology that co-occurs with the concept. In the example illustrated in FIG. 8, the corrupter accesses output data 805 of an LLM that reads “64-year-old man who has had a feeding tube removed and replaced. Also has a history of irregular heartbeats.” The corrupter detects an entity, including the phrase “irregular heartbeats,” and determines that entity corresponds to the first concept of “irregular heartbeats” in an ontology, for example, the ontology 520 illustrated in FIG. 5.

In the example of FIG. 8, the corruption rule instructs the corrupter to replace the entity detected in output data that corresponds to a first concept of the ontology with a second concept of the ontology that co-occurs with the first concept of the ontology. For example, the corrupter determines, from the ontology 520 of FIG. 5, that the fatigue 551 concept node has a cooccurrence relationship (e.g., indicated via the dashed line of edge 550 in FIG. 5) with the irregular heartbeats 527 node. In some implementations, the corrupter infers a cooccurrence relationship between concepts. For example, if both “fatigue” and “irregular heartbeat” concepts (e.g., instance nodes) have the relation “X is symptom of Y” with a “Heart disease” concept (e.g., a category node), the corrupter may consider the “fatigue” and “irregular heartbeat” concepts to be co-occurring.

In some implementations, instead of determining a co-occurrent concept that is noted in the ontology 520 itself, the corrupter accesses a cooccurrence database and determines probabilities of cooccurrence of each of a set of concepts with the concept detected in the output data. The corrupter selects, from the set of concepts, a co-occurrent concept that is in ontology 520 that has a higher probability of co-occurrence with the concept compared to other concepts in the set of concepts that are also in ontology 520. Accordingly, the corrupter replaces the “irregular heartbeats” entity in the output data 805 with “fatigue” in the corrupted output data 830. Accordingly, the corrupted output data reads, “64-year-old man who has had a feeding tube removed and replaced. Also has a history of fatigue.”

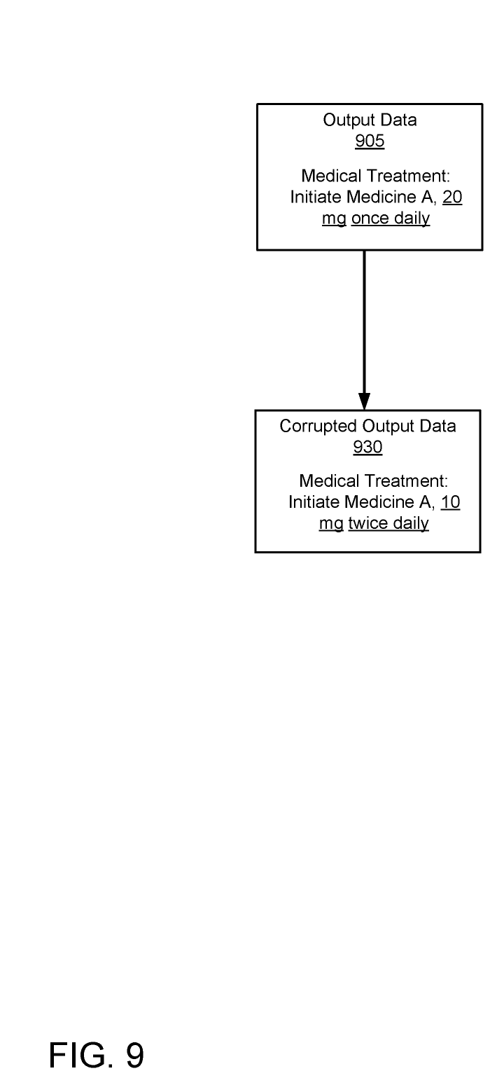

FIG. 9 illustrates the application of a corruption rule instructing to replace a value associated with an entity detected in the output data corresponding to a concept of an ontology with another value. In the example illustrated in FIG. 9, the corrupter accesses output data 905 of an LLM that reads “Medical Treatment: Initiate Medicine A, 20 mg once daily.” The corrupter detects entity values of “Medicine A,” “20 mg,” and “once daily” in the output data that have corresponding concepts in the ontology 520 illustrated in FIG. 5. For example, the data property 552 of the ontology includes each of these values detected in the output data 905.

In the example of FIG. 9, the corruption rule instructs the corrupter to replace a value associated with an entity detected in the output data that corresponds with the concept of the ontology with another value. The corrupter determines, from the ontology 520, that the “20” in “20 mg” is a numerical value and that “once” is an ordinal numerical value. The corruptor determines alternative values of “10” and “twice.” The corrupter replaces the original values of “20” and “once” in the output data 705 with “10” and “twice” in the corrupted output data 930. Accordingly, the corrupted output data 930 reads, “Medical Treatment: Initiate Medicine A, 10 mg twice daily.”

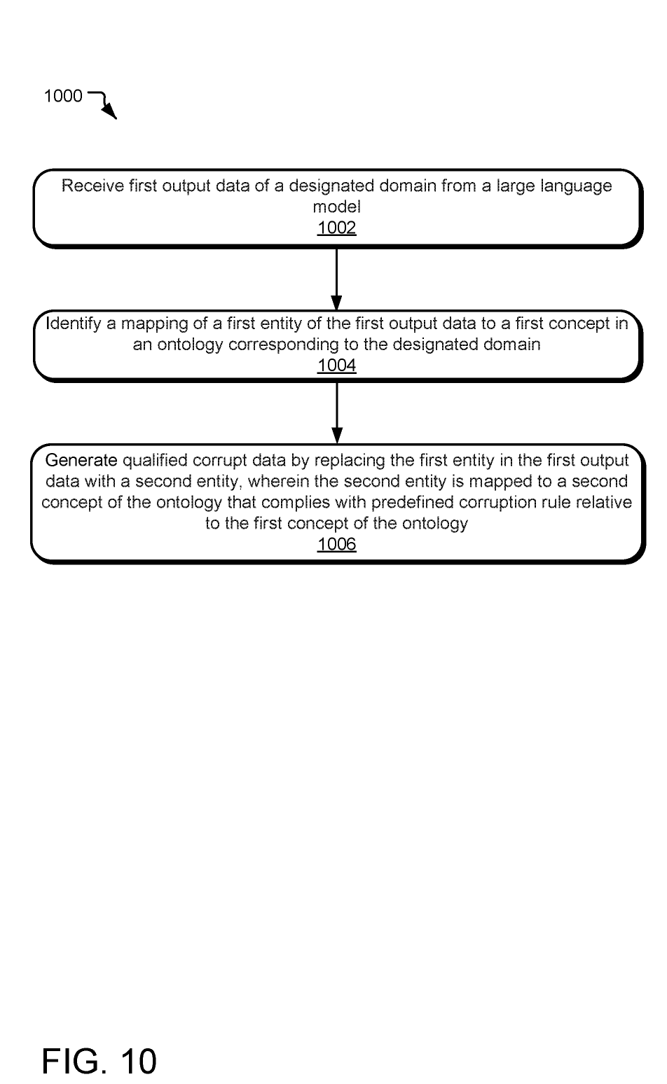

FIG. 10 depicts an example operations 1000 for corrupting output data generated by a large language model for training an error detection model. The example operations 1000 are, in some implementations, performed by a corrupter and/or a safeguard model trainer with characteristics the same or similar as the corrupters described herein with respect to FIG. 2-4.

Example operation 1002 receives first output data of a designated domain from a large language model. In some implementations, the operations further include receiving corrupt data of the designated domain from a corrupter large language model, wherein the corrupter large language model generates the corrupt data based on the output data of the large language model. In some implementations, mapping the first entity of the first output data to the first concept in the ontology includes parsing the first output data into a set of tokens, wherein the first entity is a token of the set of tokens that corresponds to the first concept of the ontology.

Example operation 1004 identifies a mapping of a first entity of the first output data to a first concept in an ontology corresponding to the designated domain. In some implementations, mapping the first entity of the first output data to the first concept in the ontology includes parsing the first output data into a set of tokens, wherein the first entity is a token of the set of tokens that corresponds to the first concept of the ontology. In some implementations, the operations further include identifying, in the corrupt data generated by a corrupter large language model, the second entity at a location in the corrupt data corresponding to a location of the first entity in the output data and determining that a relationship between the second concept and the first concept complies with the predefined corruption rule. In some instances, the operations further include identifying, in the corrupt data, a third entity at a location in the corrupt data corresponding to a location of the first entity in the output data and determining that a relationship between a third concept of the ontology corresponding to the third entity and the first concept does not comply with the predefined corruption rule.

Example operation 1006 generates qualified corrupt data by replacing the first entity in the first output data with a second entity, wherein the second entity is mapped to a second concept of the ontology that complies with predefined corruption rule relative to the first concept of the ontology. In some implementations, the predefined corruption rule specifies that the second concept and the first concept are instances of the same category concept. In some implementations, the predefined corruption rule specifies that the first concept is associated with a first node in a graph structure representing the ontology that is within a predefined range of edges from a second node in the graph structure that corresponds to the second concept. In some implementations, the predefined corruption rule specifies that the second concept and the first concept have a co-occurrence relationship. In some implementations, determining the co-occurrence relationship includes accessing co-occurrence data including, for each candidate concept of a set of candidate concepts including the second concept, a probability of co-occurrence of the candidate concept with the first concept, wherein the second concept has a highest probability of the set of candidate concepts. In some implementations, generating the qualified corrupt data includes outputting the received corrupt data received from the corrupter large language model responsive to determining that the relationship between the first concept and the second concept complies with the predefined corruption rule. In some implementations, the predefined corruption rule specifies that the second concept and the first concept are different values of the same concept. In some implementations, generating the qualified corrupt data includes, responsive to determining that the relationship between the first concept and the third concept does not comply with the predefined corruption rule, replacing the third concept with the second concept in the corrupt data to generate the qualified corrupt data.

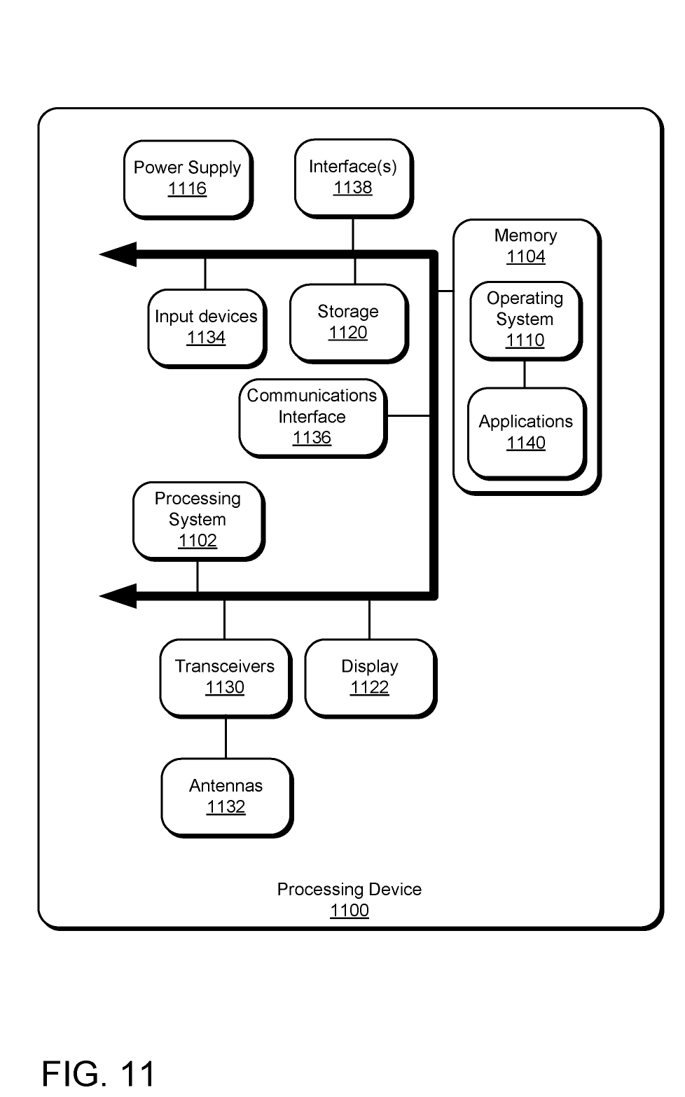

FIG. 11 illustrates an example computing device 1100 for use in implementing the described technology. The computing device 1100 may be a client computing device (such as a laptop computer, a desktop computer, or a tablet computer), a server/cloud computing device, an Internet-of-Things (IoT), any other type of computing device, or a combination of these options. The computing device 1100 includes one or more hardware processor(s) 1102 and a memory 1104. The memory 1104 generally includes both volatile memory (e.g., RAM) and nonvolatile memory (e.g., flash memory), although one or the other type of memory may be omitted. An operating system 1110 resides in the memory 1104 and is executed by the processor(s) 1102. In some implementations, the computing device 1100 includes and/or is communicatively coupled to storage 1120.

In the example computing device 1100, as shown in FIG. 11, one or more software modules, segments, and/or processors, such as applications 1140, a corrupter, an LLM, an NER, a concept linker, a synthesizer, and other program code and modules are loaded into the operating system 1110 on the memory 1104 and/or the storage 1120 and executed by the processor(s) 1102. The storage 1120 may store output data, corruption rules, one or more ontologies, corrupted output data, embedding spaces, weights, and other data and be local to the computing device 1100 or may be remote and communicatively connected to the computing device 1100. In particular, in one implementation, components of a system for generating corrupted output data from output data may be implemented entirely in hardware or in a combination of hardware circuitry and software.

The computing device 1100 includes a power supply 1116, which may include or be connected to one or more batteries or other power sources and which provides power to other components of the computing device 1100. The power supply 1116 may also be connected to an external power source that overrides or recharges the built-in batteries or other power sources.

The computing device 1100 may include one or more communication transceivers 1130, which may be connected to one or more antenna(s) 1132 to provide network connectivity (e.g., mobile phone network, Wi-Fi®, Bluetooth®) to one or more other servers, client devices, IoT devices, and other computing and communications devices. The computing device 1100 may further include a communications interface 1136 (such as a network adapter or an I/O port, which are types of communication devices). The computing device 1100 may use the adapter and any other types of communication devices for establishing connections over a wide-area network (WAN) or local-area network (LAN). It should be appreciated that the network connections shown are exemplary and that other communications devices and means for establishing a communications link between the computing device 1100 and other devices may be used.

The computing device 1100 may include one or more input devices 1134 such that a user may enter commands and information (e.g., a keyboard, trackpad, or mouse). These and other input devices may be coupled to the server by one or more interfaces 1138, such as a serial port interface, parallel port, or universal serial bus (USB). The computing device 1100 may further include a display 1122, such as a touchscreen display.

The computing device 1100 may include a variety of tangible processor-readable storage media and intangible processor-readable communication signals. Tangible processor-readable storage can be embodied by any available media that can be accessed by the computing device 1100 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 1100. In contrast to tangible processor-readable storage media, intangible processor-readable communication signals may embody processor-readable instructions, data structures, program modules, or other data resident in a modulated data signal, such as a carrier wave or other signal transport mechanism. The term "modulated data signal" means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of corrupting output data generated by a large language model for training a safeguard model, the method comprising: receiving first output data of a designated domain from the large language model; and synthesizing qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

Clause 2. The method of clause 1, wherein the second concept is an instance of a category concept, wherein the first concept is another instance of the category concept.

Clause 3. The method of clause 1, wherein the first concept is associated with a first node in a graph structure representing the ontology, wherein the second concept is associated with a second node within a predefined range of edges from the first node in the graph structure.

Clause 4. The method of clause 1, wherein the second concept has a relationship of co-occurrence with the first concept.

Clause 5. The method of clause 4, further comprising: accessing co-occurrence data including, for each candidate concept of a set of candidate concepts including the second concept, a probability of a co-occurrence of the candidate concept with the first concept, wherein the second concept has a highest probability of the set of candidate concepts.

Clause 6. The method of clause 1, further comprising: receiving corrupt data of the designated domain from a corrupter large language model, wherein the corrupter large language model generates the corrupt data based on the output data of the large language model; identifying, in the corrupt data, the second entity at a location in the corrupt data corresponding to a location of the first entity in the output data; and determining that a relationship between the second concept and the first concept complies with the predefined corruption rule, wherein generating the qualified corrupt data includes outputting the received corrupt data responsive to determining that the relationship complies with the predefined corruption rule.

Clause 7. The method of clause 1, further comprising: receiving corrupt data of the designated domain from a corrupter large language model, wherein the corrupter large language model generates the corrupt data based on the output data of the large language model; identifying, in the corrupt data, a third entity at a location in the corrupt data corresponding to a location of the first entity in the output data; and determining that a relationship between a third concept of the ontology corresponding to the third entity and the first concept does not comply with the predefined corruption rule, wherein generating the qualified corrupt data includes, responsive to determining that the relationship does not comply with the predefined corruption rule, replacing the third concept with the first concept in the corrupt data to generate the qualified corrupt data.

Clause 8. The method of clause 1, further comprising: receiving corrupt data of the designated domain from a corrupter large language model, wherein the corrupter large language model generates the corrupt data based on the output data of the large language model; identifying, in the corrupt data, a third entity at a location in the corrupt data corresponding to a location of the first entity in the output data; and determining that a relationship between a third concept of the ontology corresponding to the third entity and the first concept does not comply with the predefined corruption rule, wherein generating the qualified corrupt data includes, responsive to determining that the relationship does not comply with the predefined corruption rule, receiving subsequent corrupt data of the designated domain from the corrupter large language model.

Clause 9. The method of clause 4, wherein the first concept is a first value, wherein the second concept is a second value that is different from the first value.

Clause 10. The method of clause 1, wherein detecting the first entity in the output data generated by the large language model includes parsing the output data into a set of tokens, wherein the first entity is a token of the set of tokens that corresponds to the first concept of the ontology.

Clause 11. A system for corrupting output data generated by a large language model for training a safeguard model, comprising: one or more hardware processors; a communication interface executable by the one or more hardware processors and configured to perform operations comprising receiving first output data of a designated domain from the large language model; and a synthesizer executable by the one or more hardware processors and configured to perform operations comprising synthesizing qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

Clause 12. The system of clause 11, wherein the communication interface is further configured to receive corrupt data of the designated domain from a corrupter large language model, wherein the corrupter large language model generates the corrupt data based on the output data of the large language model, wherein the synthesizer is further configured to: identify, in the corrupt data, the second entity at a location in the corrupt data corresponding to a location of the first entity in the output data; and determine that a relationship between the second concept and the first concept complies with the predefined corruption rule, wherein generating the qualified corrupt data includes outputting the received corrupt data responsive to determining that the relationship complies with the predefined corruption rule.

Clause 13. The system of clause 11, wherein the communication interface is further configured to receive corrupt data of the designated domain from a corrupter large language model, wherein the corrupter large language model generates the corrupt data based on the output data of the large language model, wherein the synthesizer is further configured to: identify, in the corrupt data, a third entity at a location in the corrupt data corresponding to a location of the first entity in the output data; and determining that a relationship between a third concept of the ontology corresponding to the third entity and the first concept does not comply with the predefined corruption rule, wherein generating the qualified corrupt data includes, responsive to determining that the relationship does not comply with the predefined corruption rule, replacing the third concept with the first concept in the corrupt data to generate the qualified corrupt data.

Clause 14. The system of clause 11, wherein the second concept is an instance of a category concept, wherein the first concept is another instance of the category concept.

Clause 15. The system of clause 11, wherein the first concept is associated with a first node in a graph structure representing the ontology, wherein the second concept is associated with a second node within a predefined range of edges from the first node in the graph structure.

Clause 16. The system of clause 11, wherein the second concept has a relationship of co-occurrence with the first concept.

Clause 17. One or more tangible processor-readable storage media embodied with instructions for executing on one or more processors and circuits of a computing device a process for corrupting output data generated by a large language model for training a safeguard model, the process comprising: receiving first output data of a designated domain from the large language model; and synthesizing qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

Clause 18. The one or more tangible processor-readable storage media of clause 17, wherein the second concept is an instance of a category concept, wherein the first concept is another instance of the category concept.

Clause 19. The one or more tangible processor-readable storage media of clause 17, wherein the first concept is associated with a first node in a graph structure representing the ontology, wherein the second concept is associated with a second node within a predefined range of edges from the first node in the graph structure.

Clause 20. The one or more tangible processor-readable storage media of clause 17, the process further comprising: receiving corrupt data of the designated domain from a corrupter large language model, wherein the corrupter large language model generates the corrupt data based on the output data of the large language model; identifying, in the corrupt data, a third entity at a location in the corrupt data corresponding to a location of the first entity in the output data, and determining that a relationship between a third concept of the ontology corresponding to the third entity and the first concept does not comply with the predefined corruption rule, wherein generating the qualified corrupt data includes, responsive to determining that the relationship does not comply with the predefined corruption rule, replacing the third concept with the first concept in the corrupt data to generate the qualified corrupt data.

Clause 21. A system of corrupting output data generated by a large language model for training a safeguard model, the system comprising: means for receiving first output data of a designated domain from the large language model; and means for synthesizing qualified corrupt data for training the safeguard model configured to detect errors in second output of the large language model by: identifying a mapping of a first entity of the first output data to a first concept in an ontology corresponding to the designated domain, and generating the qualified corrupt data by replacing the first entity in the first output data with a second entity, wherein the second entity is mapped to a second concept of the ontology that complies with predefined corruption rule relative to the first concept of the ontology.

Clause 22. The system of clause 21, wherein the second concept is an instance of a category concept, wherein the first concept is another instance of the category concept.

Clause 23. The system of clause 21, wherein the first concept is associated with a first node in a graph structure representing the ontology, wherein the second concept is associated with a second node within a predefined range of edges from the first node in the graph structure.

Clause 24. The system of clause 21, wherein the second concept has a relationship of co-occurrence with the first concept.

Clause 25. The system of clause 24, further comprising: means for accessing co-occurrence data including, for each candidate concept of a set of candidate concepts including the second concept, a probability of a co-occurrence of the candidate concept with the first concept, wherein the second concept has a highest probability of the set of candidate concepts.

Clause 26. The system of clause 21, further comprising: means for receiving corrupt data of the designated domain from a corrupter large language model, wherein the corrupter large language model generates the corrupt data based on the output data of the large language model; means for identifying, in the corrupt data, the second entity at a location in the corrupt data corresponding to a location of the first entity in the output data; and means for determining that a relationship between the second concept and the first concept complies with the predefined corruption rule, wherein generating the qualified corrupt data includes outputting the received corrupt data responsive to determining that the relationship complies with the predefined corruption rule.

Clause 27. The system of clause 21, further comprising: means for receiving corrupt data of the designated domain from a corrupter large language model, wherein the corrupter large language model generates the corrupt data based on the output data of the large language model; means for identifying, in the corrupt data, a third entity at a location in the corrupt data corresponding to a location of the first entity in the output data; and means for determining that a relationship between a third concept of the ontology corresponding to the third entity and the first concept does not comply with the predefined corruption rule, wherein generating the qualified corrupt data includes, responsive to determining that the relationship does not comply with the predefined corruption rule, replacing the third concept with the first concept in the corrupt data to generate the qualified corrupt data.

Clause 28. The system of clause 21, further comprising: means for receiving corrupt data of the designated domain from a corrupter large language model, wherein the corrupter large language model generates the corrupt data based on the output data of the large language model; means for identifying, in the corrupt data, a third entity at a location in the corrupt data corresponding to a location of the first entity in the output data; and means for determining that a relationship between a third concept of the ontology corresponding to the third entity and the first concept does not comply with the predefined corruption rule, wherein generating the qualified corrupt data includes, responsive to determining that the relationship does not comply with the predefined corruption rule, receiving subsequent corrupt data of the designated domain from the corrupter large language model.

Clause 29. The system of clause 24, wherein the first concept is a first value, wherein the second concept is a second value that is different from the first value.

Clause 30. The system of clause 21, wherein the means for detecting the first entity in the output data generated by the large language model includes means for parsing the output data into a set of tokens, wherein the first entity is a token of the set of tokens that corresponds to the first concept of the ontology.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of corrupting output data generated by a large language model for training a safeguard model, the method comprising:
receiving first output data of a designated domain from the large language model; and
synthesizing qualified corrupt data for training the safeguard model configured to detect errors in second output of the large language model by:
identifying a mapping of a first entity of the first output data to a first concept in an ontology corresponding to the designated domain, and
generating the qualified corrupt data by replacing the first entity in the first output data with a second entity, wherein the second entity is mapped to a second concept of the ontology that complies with predefined corruption rule relative to the first concept of the ontology.

2. The method of claim 1, wherein the second concept is an instance of a category concept, wherein the first concept is another instance of the category concept.

3. The method of claim 1, wherein the first concept is associated with a first node in a graph structure representing the ontology, wherein the second concept is associated with a second node within a predefined range of edges from the first node in the graph structure.

4. The method of claim 1, wherein the second concept has a relationship of co-occurrence with the first concept.

5. The method of claim 4, further comprising:
accessing co-occurrence data including, for each candidate concept of a set of candidate concepts including the second concept, a probability of a co-occurrence of the candidate concept with the first concept, wherein the second concept has a highest probability of the set of candidate concepts.

6. The method of claim 1, further comprising:
receiving corrupt data of the designated domain from a corrupter large language model, wherein the corrupter large language model generates the corrupt data based on the output data of the large language model;
identifying, in the corrupt data, the second entity at a location in the corrupt data corresponding to a location of the first entity in the output data; and
determining that a relationship between the second concept and the first concept complies with the predefined corruption rule,
wherein generating the qualified corrupt data includes outputting the received corrupt data responsive to determining that the relationship complies with the predefined corruption rule.

7. The method of claim 1, further comprising:
receiving corrupt data of the designated domain from a corrupter large language model, wherein the corrupter large language model generates the corrupt data based on the output data of the large language model;
identifying, in the corrupt data, a third entity at a location in the corrupt data corresponding to a location of the first entity in the output data; and
determining that a relationship between a third concept of the ontology corresponding to the third entity and the first concept does not comply with the predefined corruption rule,
wherein generating the qualified corrupt data includes, responsive to determining that the relationship does not comply with the predefined corruption rule, replacing the third concept with the first concept in the corrupt data to generate the qualified corrupt data.

8. The method of claim 1, further comprising:
receiving corrupt data of the designated domain from a corrupter large language model, wherein the corrupter large language model generates the corrupt data based on the output data of the large language model;
identifying, in the corrupt data, a third entity at a location in the corrupt data corresponding to a location of the first entity in the output data; and
determining that a relationship between a third concept of the ontology corresponding to the third entity and the first concept does not comply with the predefined corruption rule,
wherein generating the qualified corrupt data includes, responsive to determining that the relationship does not comply with the predefined corruption rule, receiving subsequent corrupt data of the designated domain from the corrupter large language model.

9. The method of claim 4, wherein the first concept is a first value, wherein the second concept is a second value that is different from the first value.

10. The method of claim 1, wherein detecting the first entity in the output data generated by the large language model includes parsing the output data into a set of tokens, wherein the first entity is a token of the set of tokens that corresponds to the first concept of the ontology.

11. A system for corrupting output data generated by a large language model for training a safeguard model, comprising:
one or more hardware processors;
a communication interface executable by the one or more hardware processors and configured to perform operations comprising receiving first output data of a designated domain from the large language model; and
a synthesizer executable by the one or more hardware processors and configured to perform operations comprising synthesizing qualified corrupt data for training the safeguard model configured to detect errors in second output of the large language model by:
identifying a mapping of a first entity of the first output data to a first concept in an ontology corresponding to the designated domain, and
generating the qualified corrupt data by replacing the first entity in the first output data with a second entity, wherein the second entity is mapped to a second concept of the ontology that complies with predefined corruption rule relative to the first concept of the ontology.

12. The system of claim 11,
wherein the communication interface is further configured to receive corrupt data of the designated domain from a corrupter large language model, wherein the corrupter large language model generates the corrupt data based on the output data of the large language model, wherein the synthesizer is further configured to:
identify, in the corrupt data, the second entity at a location in the corrupt data corresponding to a location of the first entity in the output data; and
determine that a relationship between the second concept and the first concept complies with the predefined corruption rule, wherein generating the qualified corrupt data includes outputting the received corrupt data responsive to determining that the relationship complies with the predefined corruption rule.

13. The system of claim 11,
wherein the communication interface is further configured to receive corrupt data of the designated domain from a corrupter large language model, wherein the corrupter large language model generates the corrupt data based on the output data of the large language model, wherein the synthesizer is further configured to:
identify, in the corrupt data, a third entity at a location in the corrupt data corresponding to a location of the first entity in the output data; and
determining that a relationship between a third concept of the ontology corresponding to the third entity and the first concept does not comply with the predefined corruption rule, wherein generating the qualified corrupt data includes, responsive to determining that the relationship does not comply with the predefined corruption rule, replacing the third concept with the first concept in the corrupt data to generate the qualified corrupt data.

14. The system of claim 11, wherein the second concept is an instance of a category concept, wherein the first concept is another instance of the category concept.

15. The system of claim 11, wherein the first concept is associated with a first node in a graph structure representing the ontology, wherein the second concept is associated with a second node within a predefined range of edges from the first node in the graph structure.

16. The system of claim 11, wherein the second concept has a relationship of co-occurrence with the first concept.

17. One or more tangible processor-readable storage media embodied with instructions for executing on one or more processors and circuits of a computing device a process for corrupting output data generated by a large language model for training a safeguard model, the process comprising:
receiving first output data of a designated domain from the large language model; and
synthesizing qualified corrupt data for training the safeguard model configured to detect errors in second output of the large language model by:
identifying a mapping of a first entity of the first output data to a first concept in an ontology corresponding to the designated domain, and
generating the qualified corrupt data by replacing the first entity in the first output data with a second entity, wherein the second entity is mapped to a second concept of the ontology that complies with predefined corruption rule relative to the first concept of the ontology.

18. The one or more tangible processor-readable storage media of claim 17, wherein the second concept is an instance of a category concept, wherein the first concept is another instance of the category concept.

19. The one or more tangible processor-readable storage media of claim 17, wherein the first concept is associated with a first node in a graph structure representing the ontology, wherein the second concept is associated with a second node within a predefined range of edges from the first node in the graph structure.

20. The one or more tangible processor-readable storage media of claim 17, the process further comprising:
receiving corrupt data of the designated domain from a corrupter large language model, wherein the corrupter large language model generates the corrupt data based on the output data of the large language model;
identifying, in the corrupt data, a third entity at a location in the corrupt data corresponding to a location of the first entity in the output data, and
determining that a relationship between a third concept of the ontology corresponding to the third entity and the first concept does not comply with the predefined corruption rule,
wherein generating the qualified corrupt data includes, responsive to determining that the relationship does not comply with the predefined corruption rule, replacing the third concept with the first concept in the corrupt data to generate the qualified corrupt data.
